(19) United States
(12) Patent Application Publication
(10) Pub. No.: US 2002/0140665 A1
(43) Pub. Date: Oct. 3, 2002

(54) Method for framing viewports on a computer screen, and for pointing therein

(76) Inventor: Gary Gordon, Saratoga, CA (US)

Correspondence Address: Gary Gordon, 21112 Bank Mill Rd., Saratoga, CA, 95070, US

(21) Appl. No.: 09/818,386

(22) Filed: Mar. 27, 2001

(51) Int. Cl. G09G 5/08

(52) U.S. Cl. 345/156

(57) ABSTRACT

A method provides computer applications with an integrated means for displaying and interacting with large workpieces, through the use of smaller viewports. In a first mode, the method uses a mouse to position a viewport, and its scroll to adjust its size, in a manner analogous to the way television cameras are panned, tilted, and zoomed. In a second mode, the method controls the position of a screen cursor in a conventional manner. The selection between the first framing mode and the second pointing mode is made by the user depressing the scroll wheel. By integrating framing and pointing, a fast and intuitive method is provided for managing and processing large and unwieldy workpieces such as documents, spreadsheets, drawings, photographs, games, and maps.

### BACKGROUND—FIELD OF INVENTION

This invention relates to framing viewports on computer screens, and also to computer mice. It also relates directly or indirectly to screen scroll bars, mouse scroll wheels. It further relates to the control of screen magnification.

### BACKGROUND—DESCRIPTION OF PRIOR ART

A well-known adjunct of desktop computers is the computer mouse, used to control a cursor arrow so as to point to objects on a workpiece displayed on the screen. The objects pointed to vary widely, depending on the software application and thus the workpiece. Examples of workpieces include text in a document, cells in a spreadsheet, lines in a drawing, and features in a photograph.

In many cases, the workpiece is so large that it would become un-readably small if displayed in its entirety. Thus, most software applications provide a means to select a viewport, the portion of the workpiece shown on the screen. More specifically, the applications provide a means to move the viewport horizontally and vertically, as well as vary its size.

This need to move and scale the viewport has long been recognized, and addressed in a variety of manners. For example, in Microsoft Word, scroll bars are provided at the side and bottom of the screen, and a pull-down menu is used to select the percentage magnification. Many Microsoft applications use a similar convention. Another technique common to newer Microsoft applications is the addition of a scroll wheel to the mouse, which is used to move the viewport vertically within documents.

In a different example, the AutoCAD drawing program by AutoDesk provides tool bar picks, used first to zoom out in a drawing, and then to use the mouse to drag a box around a smaller area, for magnified viewing. Still another method used in some UNIX applications is to sense when the cursor has reached the edge of the screen, and then “push” the viewport in that direction accordingly.

These methods used in the prior art are not without shortcomings. First, neither positioning nor sizing of viewports are handled very well, and certainly not in an integrated manner. For positioning, scroll bars are narrow, making it difficult to move them while not sliding off their sides. There are two of them, requiring a longer time to manipulate. Finally, they are not proportional to screen magnification, so it takes a high degree of dexterity to for example when working zoomed in tight on an image, to move the viewport a small amount. Scroll wheels are easier to use, but only work in one direction. Moving the viewport by sensing when the cursor reaches the edge of the screen does not offer very high accuracy, and generally entails nudging the mouse repeatedly at alternate sides of the screen to achieve the desired result.

Sizing the viewport does not fare much better. The tool bar picks used by the most popular CAD and photographic programs AUTOCAD and PHOTOSHOP are slow to use, and allow zooming only in fixed amounts. The menu pick method used in Microsoft Word requires either a keyboard entry of a percentage magnification, or choosing one of a limited set of standard values.

To exacerbate these limitations of the prior art, the positioning and sizing the viewport are treated as independent, un-integrated activities. As such, they are slow, tedious, and their unnecessary steps may even contribute to hand and wrist injuries. Despite 30 years of software and hardware advances, the need still stands for an improved and integrated concept for framing viewports.

### SUMMARY OF THE INVENTION

In the present invention, the conventions used for controlling studio and remote television cameras are borrowed and merged with conventions used to control computer screen cursors, to effect an integrated environment that allows a more efficient computer interaction. More specifically, conventions used in the broadcast industry for panning, tilting, and zooming television cameras are mapped onto a computer's mouse and software, to accomplish the framing and sizing of a viewport displayed on the screen of a computer. In the context of the present invention, this mimicking may be referred to as effecting television-camera like framing of a viewport. When implemented, considerable functionality is added to a mouse that would otherwise mainly control the motion of the cursor.

In this invention, a suite of five input activities is implemented: moving the cursor both horizontally and vertically, moving a viewport both horizontally and vertically; and preferably, also controlling the size of the viewport. Control of these activities is by means of a mouse or other pointing device equipped with a motion encoder, a switch, and preferably a scroll wheel. The motion encoder needs to be capable of encoding at least two axes of motion, as for example, X and Y. In the preferred embodiment, pressing down on the scroll wheel actuates the switch. When the switch is actuated, software residing in the computer selectively redirects the mouse motion and scroll-wheel inputs in a manner to be described.

In a first mode of operation of the invention, traversing the mouse in X and Y (horizontally and vertically) across the work surface causes the cursor to follow the motions, in a conventional manner. This first mode would be used, for example, in adding a line to a mechanical drawing.

A second mode of operation of the invention is activated by pressing and holding down the switch on the scroll wheel. In this mode, the mouse ceases to control the cursor, and instead controls the position of the viewport. For example, if the mouse is moved to the left, then the workpiece seen on the screen would move to the right, exposing a view of the workpiece more leftward; in other words, the viewport is moved to the left. Of course, if the mouse while in this mode is moved diagonally, the viewport correspondingly moves diagonally. Operation in this mode is analogous to operating the pan/tilt handle of a tripod-mounted television camera,or similarly operating the joystick of a remote controller for a robotic pan/tilt camera head.

Further, in the second mode, in a preferred embodiment, rotating the mouse's scroll wheel causes the viewport to grow or shrink in size. This operation is analogous to operating the zoom controls of a television camera or robotic camera controller. In both of these cases, it is common for the zoom control to be located on or near the pan/tilt handle or joystick, and to be operated with the same hand.

It is desirable in this mode to scale the effect of the X and Y inputs to be proportional (or otherwise related) to the degree of zoom, so that the motion is more proportional to the size of what is being displayed in the viewport, rather than any absolute scaling. For example, and unlike when using scroll bars, when one is zoomed in tight on an image, the ratio between the mouse movement and the number of pixels moved should be much greater than the ratio when the whole image is being viewed, so as to afford fine control.

In the present invention, both the first and second mouse modes are used interchangeably and cooperatively. Consider again the previous case of a person adding a line on a mechanical drawing. The user first frames the region of interest, by pressing down the scroll wheel, and using the mouse and scroll wheel cooperatively to position and size the viewport. Once framed, releasing the switch returns the mouse to its normal mode, allowing the line to be drawn. Both aspects merge into an intuitive and continuous activity, requiring little conscious thought. The user is freed from distractions involving framing the viewport, and instead is freed to concentrate on their design or other task at hand.

### BRIEF DESCRIPTION OF THE DRAWINGS

FIG. 1 depicts a viewport into representative workpiece, a schematic drawing.

FIG. 2 depicts a computer mouse with a scroll wheel, and a block diagram of the process by which the mouse inputs are interpreted.

### DESCRIPTION OF A PREFERRED EMBODIMENT

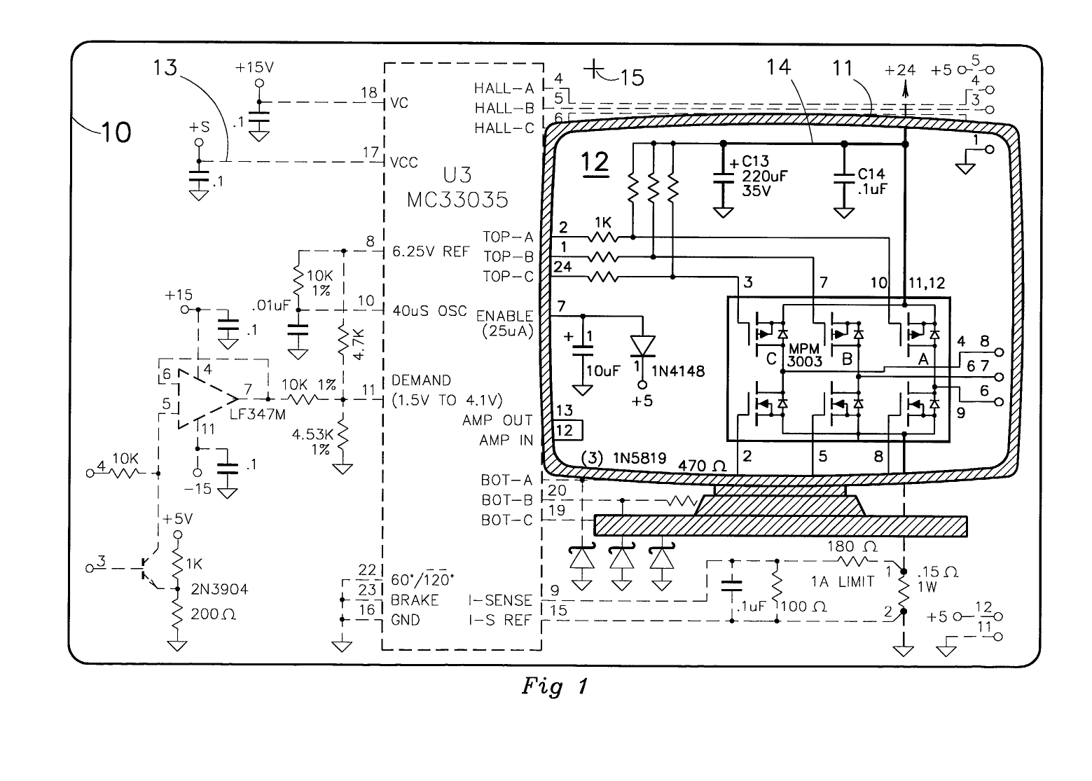

FIG. 1 depicts a representative workpiece 10 being created on a computer, using a drawing program. The workpiece example is an electronic schematic drawing comprising symbols and lines 13,14. It is intended to represent a workpiece too extensive to view in its entirety on a monitor 11, so only a portion 12 has been chosen for display. This portion is referred to as the viewport.

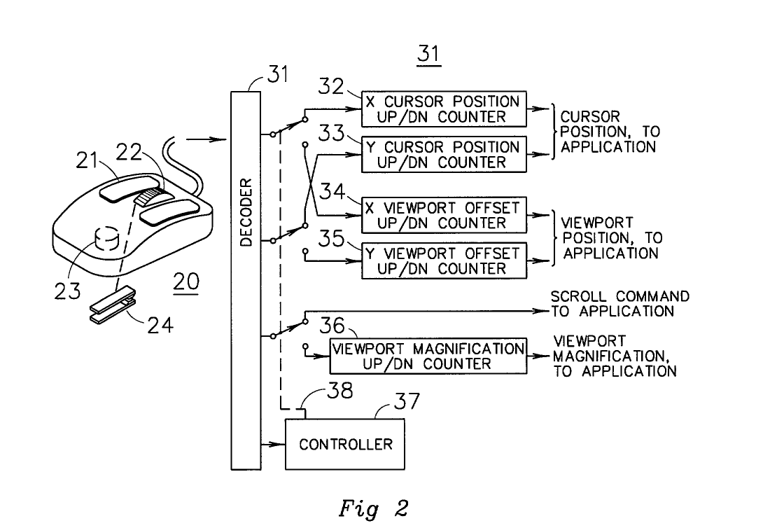

In creating this drawing, the user moves a mouse and uses its usual buttons employs a mouse 20 and its buttons 21, FIG. 2, to choose schematic symbols and draw connecting lines 13,14 in the usual manner. The mouse is also fitted with an otherwise conventional scroll wheel 22, whose normal use is for scrolling documents up and down. In the preferred embodiment this scroll wheel employs a pressure-actuated switch 24. The scroll wheel is operative regardless of the state of the switch.

In creating this drawing, a user will normally work on one section at a time, magnifying it to fill the viewport, which is framed in a manner presently to be described.

When the scroll wheel 22 is not pressed, and therefore switch 24 is open, the mouse performs in a normal manner, and mouse-motion signals from its sensor 23 are used to direct the motion of the cursor cross-hairs 15. When the switch 23 is actuated, the signals from the sensor 23 are redefined as commands to move the viewport horizontally and vertically.

If the user were constructing the workpiece 10 in a rightwards direction, they would from time to time move the viewport 12 to the right, by pressing the scroll wheel, and moving the mouse to the right. The amount the viewport moves is proportional to the distance the mouse moves, according to a scaling factor set in software. The viewport may be moved vertically in a similar manner, or on a diagonal;

or for that matter, along any path defined by the motion of the mouse.

In addition, provisions are made to easily change the magnification of the viewport 12, by using the scroll wheel 22. For example, to zoom out, the user would press the scroll wheel 22, actuating the switch 23, and then roll the wheel to adjust the magnification. With minimal practice, users learn to press and operate the scroll wheel and the mouse in a coordinated and reflexive manner, with the ease and accuracy of an experienced television camera operator.

Flow diagram 31 representing software for the preferred embodiment is shown in FIG. 2. Preferably, this software is situated in the operating system of the computer, and its functionality has a consistent look and feel across the various applications running under it.

Signals from the mouse motion sensor 23, its switches 21, 24, and its scroll wheel 22 are combined and sent in serial format to the computer, to a decoder 31 that buffers the incoming data. A controller 37 first notes the state of the scroll wheel switch 24, and uses this information to set a switch 38 to direct the signals from the motion sensor 23 to the proper destination. If the mouse switch 24 is open, the controller sets software switch 38 such that the signals are routed to the normal up/down counters 32, 33 that track the screen cursor 15. Alternatively, if the mouse switch 24 is closed, the switch 38 is set such that the motion signals are routed to the different counters 34, 35, used to keep track of the coordinates of the viewport. Additionally in this mode, the incremental signals from the mouse scroll wheel 22 are re-directed into counter 36, which controls the magnification of the viewport. In the preferred embodiment, the controller 37, switch 38, and the five counters are implemented in software.

Although a preferred embodiment has been described around the example of mechanical drawings, the scope of the invention is applicable to many other software applications as well as platforms. For example, the workpiece could be anything too large to view on the screen at one time, such as spreadsheets, photographs, graphic arts, documents, and games. The invention can be implemented either in the applications software, the operating system, or somewhere else. The invention can be practiced on a variety of platforms other than a desktop, laptop, or palm computer. Examples include digital appliances such as personal organizers, cell phones, cameras, and portable games, just to mention a few. The pointing device, besides being a mouse, could equally well be a track ball, joystick, force-sensing stick, optical sensor, sensing-pad, or any other device capable of sensing force or movement in two directions. The centering of the viewport can be positional, as described, or alternatively slewed at some velocity. Additionally, the relationship between the distance the viewport is translated and the distance the mouse or other controller is moved does not need to be proportional; for example, what is known in the art as mouse acceleration may be incorporated. The term scroll wheel refers to either a wheel that turns, a knob that twists, or to rocker switches or other switches that can be tapped, or held down so as to cause continuous zooming in or out as long as they are held, or operated in other modes such that zooming is effected. Further, the scroll wheel may be any sensor whatsoever that is capable of encoding at least one axis of motion. Further, the switch that selects between the two modes may be attached to the scroll wheel, or proximal to it or another type of sensor, or at any other location.

I claim:

1. A method for effecting television-camera like framing of a viewport into a workpiece on a screen, and controlling the position of a screen cursor, said method comprising the steps of:
in a first mode, controlling the horizontal and vertical movement of the screen cursor with a pointing device capable of encoding two axes of motion; and
in a second mode, controlling the horizontal and vertical movement of a viewport using the same said pointing device and the same said two axes of motion;
wherein the selection of either the first mode or second mode is made by the user.

2. The method as recited in claim 1, wherein the pointing device is a computer mouse, and the selection of either the first mode or the second mode is made by the user actuating a switch on said mouse.

3. The method as recited in claim 2, wherein said selection by the user between the first mode and the second mode is made by the user pressing a scroll wheel on the mouse; and
wherein when operated in the second mode, signals from the scroll wheel are used to control the magnification of the viewport.

4. The method as recited in claim 1, wherein the said horizontal and vertical movement of a viewport is made increasingly less sensitive, as the viewport is framed more tightly.

5. The method as recited in claim 1, residing in the operating system of a computer, wherein both cursor position signals and scroll signals are made available to applications programs capable of running on the computer.

6. The method as recited in claim 1, residing in an appliance, wherein the selection of either the first mode or the second mode is made by the user operating a switch proximal to the pointing device.

7. A program for effecting television-camera like framing of a viewport into a workpiece on a screen, and controlling the position of a screen cursor, said program comprising the steps of:
in a first mode, controlling the horizontal and vertical movement of the screen cursor with a pointing device;
in a second mode, controlling the horizontal and vertical movement of a viewport, using the same said pointing device;
wherein the selection of either the first mode or second mode is made by the user.

8. A program as recited in claim 6, which resides in the operating system of a computer.

9. The program as recited in claim 6, wherein said selection by the user between the first mode and the second mode is made by the user pressing a scroll wheel on a mouse; and
wherein when operated in the second mode, signals from the scroll wheel are used to control the magnification of the viewport.

10. A computer applications program that employs television-like framing of a viewport into a workpiece on a screen, and control of the position of a screen cursor, said program comprising the steps of:
in a first mode, controlling the horizontal and vertical movement of the screen cursor with a pointing device capable of encoding at least two axes of motion;
in a second mode, controlling the horizontal and vertical movement of a viewport, using the same said pointing device;
wherein the selection of either the first mode or second mode is made by the user pressing a scroll wheel on the mouse; and
wherein when operated in the second mode, signals from the scroll wheel are used to control the magnification of the viewport.

11. An applications program as in claim 9 wherein the workpiece is a drawing, or an image, or a spreadsheet, or a document, or a map, or a game.
